(19) United States
(12) Patent Application Publication
(10) Pub. No.: US 2013/0194165 A1
(43) Pub. Date: Aug. 1, 2013

(54) LIGHT-EMITTING PANEL AND HEAD UP DISPLAY INCLUDING THE SAME

(71) Applicant: OKI DATA CORPORATION, Tokyo (JP)

(72) Inventors: Satoshi TANAKA, Takasaki (JP); Kenichi TANIGAWA, Takasaki (JP)

(73) Assignee: OKI DATA CORPORATION, Tokyo (JP)

(21) Appl. No.: 13/748,669

(22) Filed: Jan. 24, 2013

(30) Foreign Application Priority Data
Jan. 27, 2012 (JP) 2012-014766

(51) Int. Cl. F21V 5/00

(52) U.S. Cl. CPC F21V 5/007
USPC 345/8; 362/240

(57) ABSTRACT

A light-emitting panel includes semiconductor light-emitting devices each having a first surface and a second surface, the first surface being placed on a surface of a substrate; lenses each provided in close contact with at least a center portion of the second surface of a corresponding semiconductor light-emitting device. The light-emitting panel further includes a connection wiring being in contact with a region around the center portions while having openings corresponding to the respective center portions.

### CROSS REFERENCE TO RELATED APPLICATIONS

This application claims priority based on 35 USC 119 from prior Japanese Patent Application No. 2012-014766 filed on Jan. 27, 2012, entitled “LIGHT-EMITTING PANEL AND HEAD UP DISPLAY INCLUDING THE SAME”, the entire contents of which are incorporated herein by reference.

### BACKGROUND OF THE INVENTION

### Field of the Invention

This disclosure relates to a light-emitting panel including a light-emitting device array with microlenses and a head up display including the light-emitting panel.

Light-emitting devices are conventionally classified into a spontaneous light-emitting device and a non-spontaneous light-emitting device from a viewpoint of the light-emitting mechanism. The spontaneous light-emitting device includes a light emitting diode (LED), an organic electroluminescent (EL) device, an inorganic EL device, and the like, while the non-spontaneous light-emitting device includes a liquid crystal (LC) device and the like.

An image display apparatus using a spontaneous light-emitting device array includes the spontaneous light-emitting devices arranged in a two-dimensional matrix, and has a lower light loss leading to higher light utilization efficiency than a light-bulb image display apparatus using non-spontaneous light-emitting devices, such as liquid crystal devices. In particular, a direct-view image display apparatus can be made lighter and thinner because back light is not used.

Using imaging devices formed of non-spontaneous light-emitting devices such as LCs, a projection-type image display apparatus such as a head up display (HUD), a projector or a rear projection apparatus, additionally requires a light source. However, when the spontaneous light-emitting devices are used in the imaging apparatus, the apparatus does not additionally require a light source and an optical system, because the light-emitting devices themselves serve as the light source. In this case, the apparatus can be made smaller.

A spontaneous light-emitting type imaging apparatus formed of LEDs maybe configured with a two-dimensional simple matrix. For example, a two-dimensional light-emitting device array and wirings formed on a plane is disclosed in Japanese Patent Application Publication No. 2010-177224.

A HUD has optical elements, such as a concave mirror and a reflection mirror, and thus has a long optical path length. This leads to a small solid angle (effective angle) of light from a light source with respect to the concave mirror.

For example, when a light-emitting device array is used for a HUD having a display magnification of five times, alight distribution characteristic of each light-emitting device exhibits a Lambertian distribution, and the effective angle from the optical axis direction is 10° to 20°. In this case, the problem arises that the light utilization efficiency of the light-emitting device array is only approximately several percent, which is extremely low.

### SUMMARY OF THE INVENTION

Hence, one conceivable way to enhance the light utilization efficiency is to form a microlens array on the light-emitting device array. The microlens array narrows an angle of the light distribution characteristic and thereby increases the light incident at a usable angle of the HUD.

However, in a conventional light-emitting device array and a head up display apparatus using the light-emitting device array, external light such as, for example, sun light entering the head up display apparatus is guided to the light-emitting device array by a concave mirror and a planar mirror. The sun light (the external light) is concentrated on the light-emitting devices by the microlenses formed in close contact with the light-emitting device array, and locally generates heat. Such a local temperature rise causes the problem of light-emitting device characteristic deterioration, such as a brightness deterioration.

An object of an embodiment of the invention is to provide a light-emitting panel configured to effectively release the heat that external light generates locally in thin-film semiconductor light-emitting devices and a head up display including the light-emitting panel.

A first aspect of the invention is a light-emitting panel that includes: a substrate; semiconductor light-emitting devices each having a first surface and a second surface, the first surface being placed on a surface of the substrate; lenses each provided in close contact with at least a center portion of the second surface of the corresponding semiconductor light-emitting device; and a connection wiring being in contact with a region around the center portions while having openings corresponding to the respective center portions.

A second aspect of the invention is a head up display that includes: the light-emitting panel according to the first aspect; and an optical system configured to visualize, as a virtual image, an image formed by the light-emitting panel.

These aspects make it possible to conduct heat generated in the thin-film semiconductor light-emitting devices through the connection wiring and to effectively release the heat to the outside of the light-emitting panel. Accordingly, the heat that external light generates locally in the thin-film semiconductor light-emitting devices can be effectively released.

This prevents characteristic deterioration due to a temperature rise in the thin-film semiconductor light-emitting devices.

### BRIEF DESCRIPTION OF THE DRAWINGS

FIG. 1 is an outline perspective diagram for explaining an image display module in a First Embodiment of the invention.

FIG. 2 is a circuit diagram for illustrating an equivalent circuit of the image display module in FIG. 1.

FIG. 3 is a schematic configuration diagram for explaining an anode driver IC and cathode driver ICs of the image display module.

FIG. 4 is an outline planar diagram showing a periphery of a light-emitting device array chip of the image display module.

FIG. 5A is a planar diagram of pixels in a 4×4 matrix for explaining a chief part of a light-emitting device array of the light-emitting device array chip.

FIG. 5B is a cross-sectional diagram of a unit pixel of the light-emitting device array, viewed in a row direction.

FIG. 5C is a cross-sectional diagram of the unit pixel of the light-emitting device array, viewed in a column direction.

FIGS. 6A(a) to 6A(c) are cross-sectional diagrams for explaining a manufacturing process of a light-emitting device.

FIG. 6B is a cross-sectional diagram for explaining an example of the light-emitting device.

FIGS. 7A and 7B are configuration diagrams for explaining an operation of a head up display apparatus of the First Embodiment.

FIG. 8 is a cross-sectional diagram of a light-emitting device for explaining heat conduction using external light.

FIG. 9A is a planar diagram of pixels in a 4×4 matrix for explaining a chief part of a light-emitting device array of the light-emitting device array chip in a Second Embodiment of the invention.

FIG. 9B is a cross-sectional diagram of a unit pixel of the light-emitting device array, viewed in the row direction.

FIG. 9C is a cross-sectional diagram of the unit pixel of the light-emitting device array, viewed in the column direction.

### DETAILED DESCRIPTION OF EMBODIMENTS

Descriptions are provided hereinbelow for embodiments based on the drawings. In the respective drawings referenced herein, the same constituents are designated by the same reference numerals and duplicate explanation concerning the same constituents is omitted. All of the drawings are provided to illustrate the respective examples only.

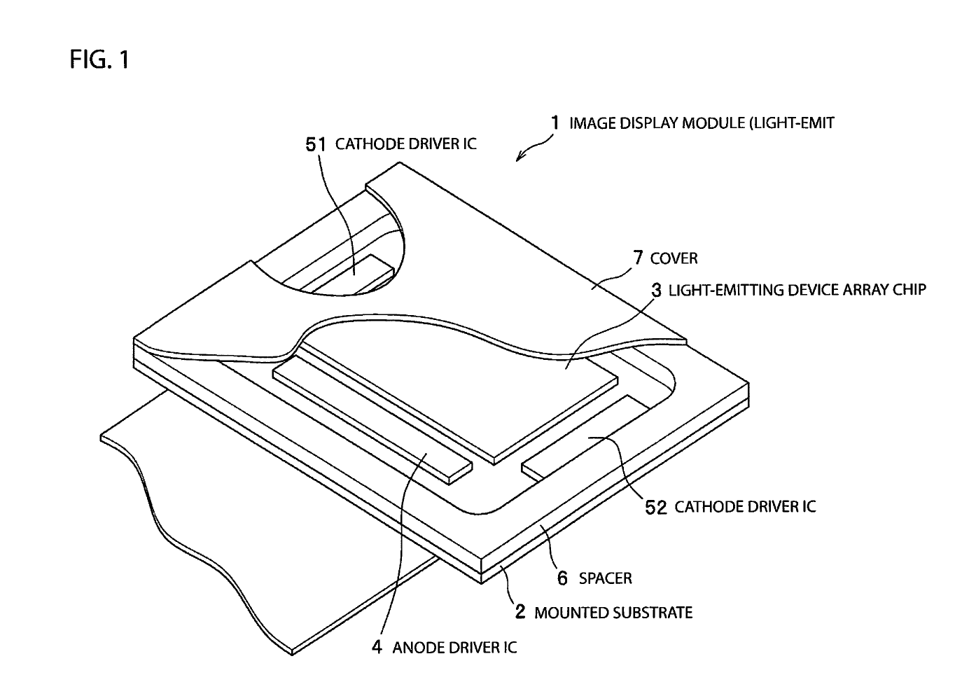

Descriptions are provided for embodiments of the invention with reference to FIGS. 1 to 9C. Note that the same reference signs denote the same components in the drawings. Hereinbelow, the embodiments of the invention are described in order by referring to the drawings.

### First Embodiment

A description is provided for the First Embodiment of the invention with reference to FIGS. 1 to 8.

### Configuration

FIG. 1 is an outline perspective diagram for explaining the entire image display module 1 in the First Embodiment of the invention. Image display module 1 includes mounted substrate 2 for mounting a semiconductor chip (for example, a chip on board: COB). Mounted substrate 2 is formed with a silicon substrate, a glass epoxy substrate, an alumina substrate, an aluminum nitride (AlN) substrate, a metal substrate, a metal core substrate or the like and includes an unillustrated wiring pattern and the like formed in a surface thereof.

Light-emitting device array chip 3 formed by using thin-film semiconductor light-emitting devices (for example, LEDs), anode driver integrated circuit 4 (hereinafter, referred to as “anode driver IC 4”) which is a driving circuit for driving light-emitting device array chip 3, and cathode driver ICs 51, 52 are fixed on a surface of mounted substrate 2.

Light-emitting device array chip 3 is connected to anode driver IC 4 and cathode driver ICs 51, 52 by using the unillustrated wiring pattern in mounted substrate 2. Here, to electrically connect light-emitting device array chip 3 to anode driver IC 4 and cathode driver ICs 51, 52 by using metal wires, light-emitting device array chip 3, anode driver IC 4, and cathode driver ICs 51, 52 are bonded to mounted substrate 2 by using a silver paste or a resin.

Cover 7 is attached to the surface of mounted substrate 2 with frame-shaped spacer 6 placed therebetween. The cover 7 protects light-emitting device array chip 3, anode driver IC 4, and cathode driver ICs 51, 52. Spacer 6 is designed to have a thickness larger than the height from the mounted surface of mounted substrate 2 to the highest portion of the metal wires. A display portion of cover 7 corresponding to light-emitting device array 8 in light-emitting device array chip 3 is desirably made of a material having a light transmittance of 80% or higher (such as glass, an acrylic resin or a polycarbonate resin). A peripheral portion other than the display portion of cover 7 desirably has a visible light transmittance of 0.1% or lower by using or applying an opaque material to the peripheral portion. Making the transmittance of the peripheral portion of cover 7 0.1% or lower can reduce image mirroring due to reflection of light emitted from light-emitting device array chip 3 on the metal wires and other components, such as anode driver IC 4 and cathode driver ICs 51, 52.

A heat sink and a metal housing which are not shown are attached to a back surface of mounted substrate 2. An unillustrated heat-dissipating paste or sheet having insulating properties is provided between the back surface of mounted substrate 2 and the heat sink and the metal housing to efficiently release heat emitted from light-emitting device array chip 3. Here, a resin or the like may be used for bonding between mounted substrate 2 and spacer 6 and between spacer 6 and cover 7. Alternatively, screws may be used to fix mounted substrate 2, the heat sink, and the metal housing together on the back surface of mounted substrate 2, after screw holes are formed in mounted substrate 2, spacer 6, and cover 7. An integrally formed spacer 6 and cover 7 and an integrally formed mounted substrate 2 and spacer 6 may also be used.

In this embodiment, two cathode driver ICs are provided in the image display module, but one, or three or more cathode driver ICs may be provided depending on the circuit configuration. Further, light-emitting device array chip 3, an anode driver IC, and the cathode driver ICs may be provided in an arrangement different from the illustrated arrangement. Still further, an IC including the anode driver IC, the cathode driver ICs, and a controller which are integrated on one chip may be used.

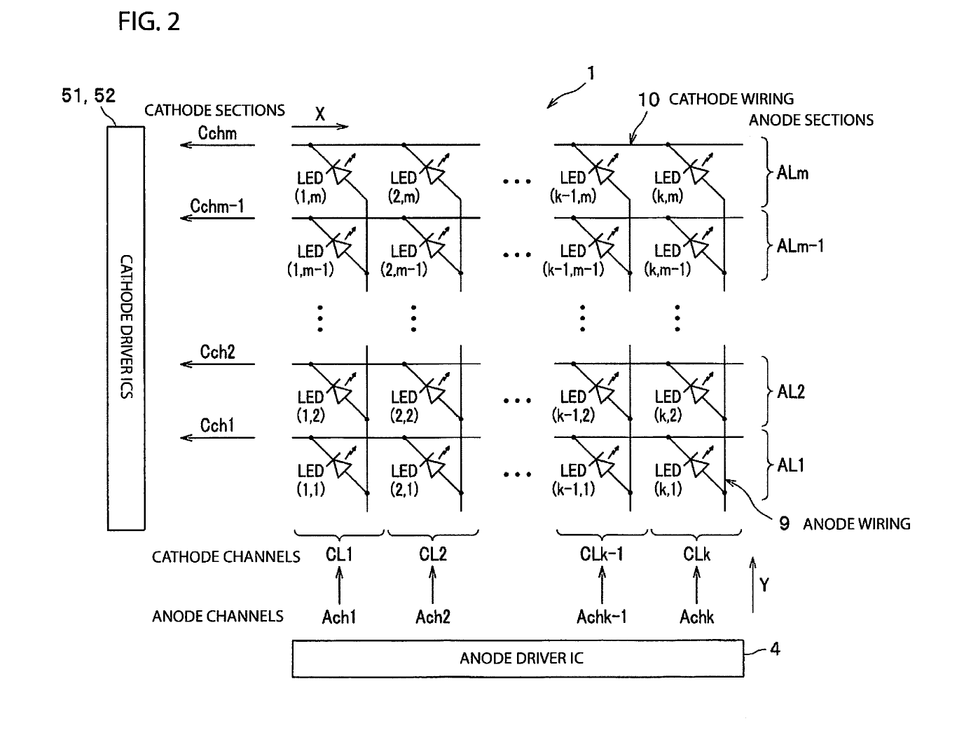

FIG. 2 is a circuit diagram for illustrating an equivalent circuit of the image display module 1 in FIG. 1. A configuration described for simplicity is the use of anode driver IC 4 and one of cathode driver ICs 51, 52. Light-emitting device array chip 3 in image display module 1 is formed by a passive LED dot matrix with m rows and k columns, for example.

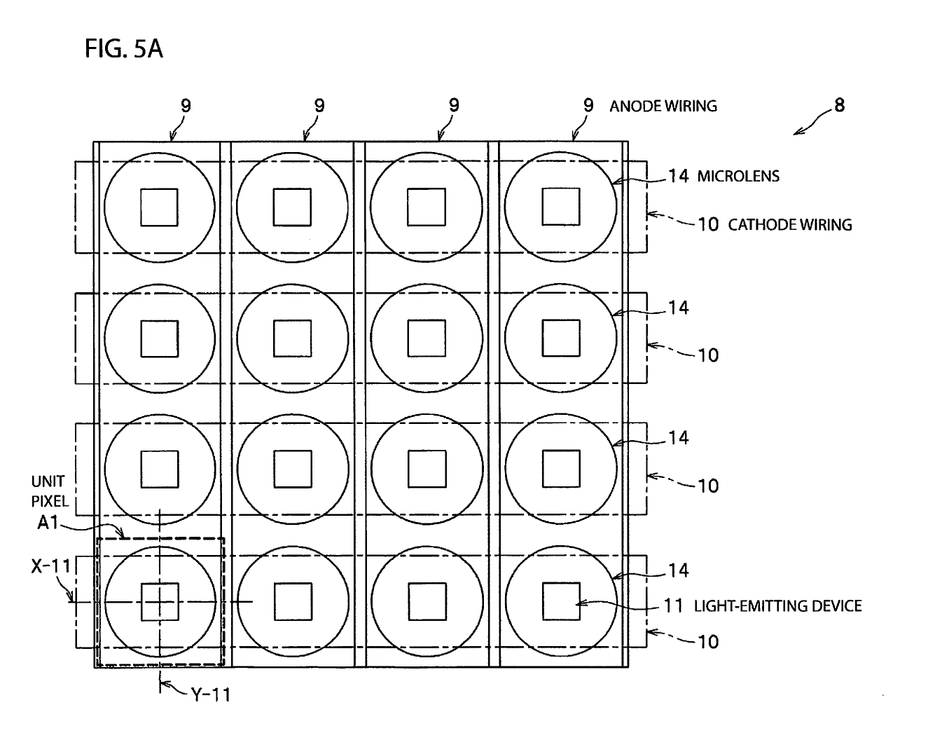

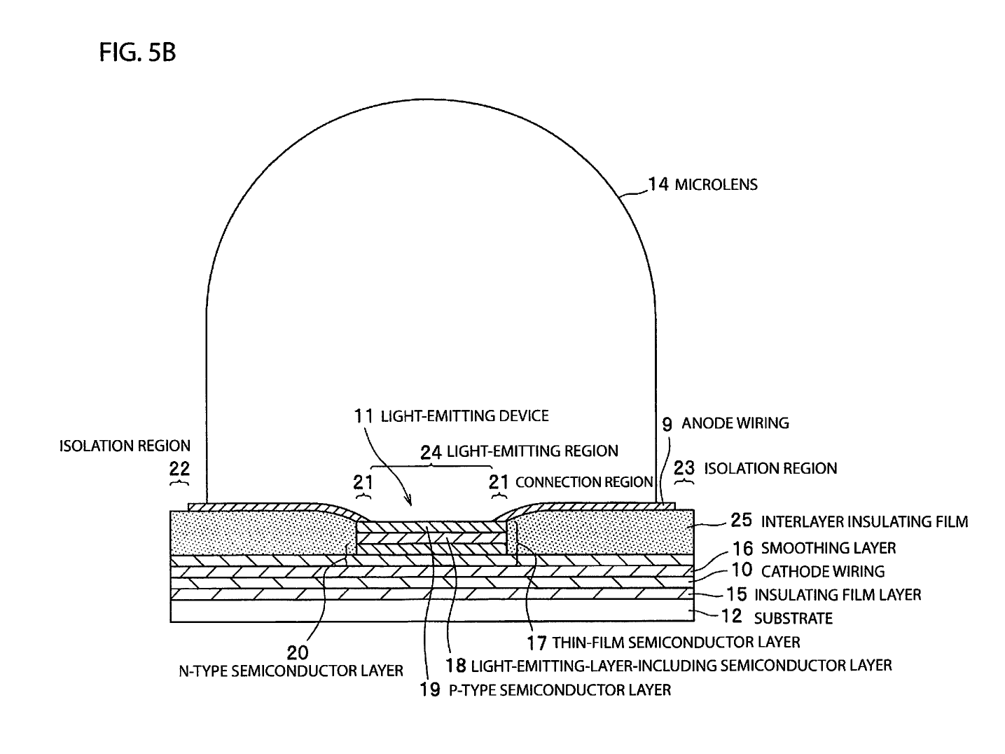

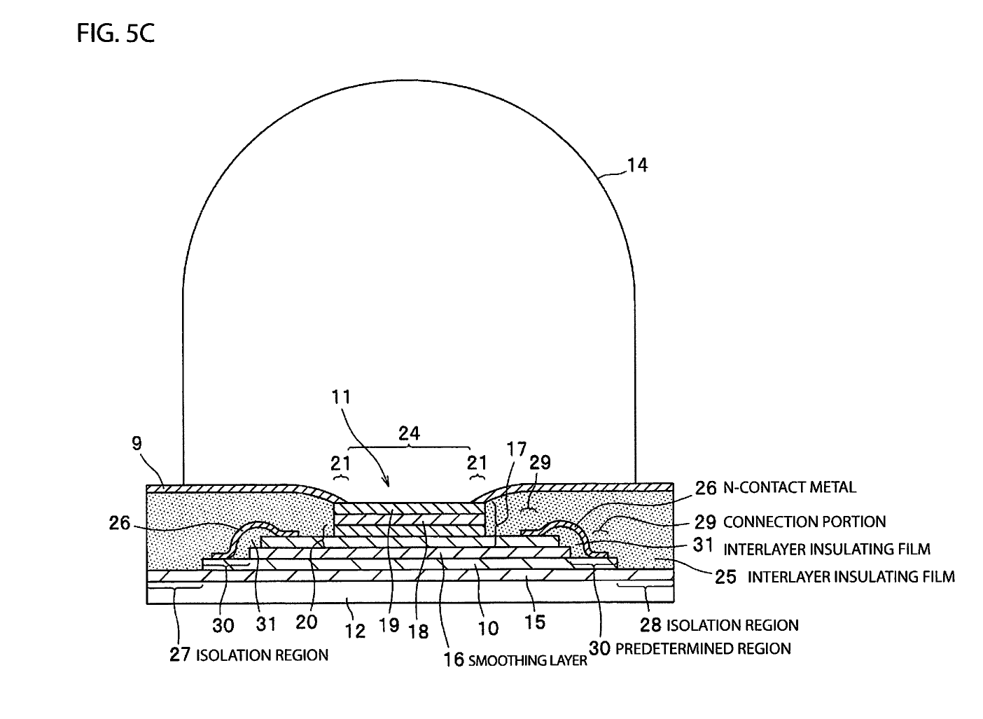

In the row direction (a horizontal direction) X, k anode wirings 9 forming anode channels Ach are arranged in parallel. In the column direction (a vertical direction) Y crossing anode wirings 9 and anode channels Ach, m cathode wirings 10 forming cathode channels Cch are arranged in parallel. At crossing points thereof, k×m LEDs (1, 1) to LED (k, m) are connected to each other. Here, an index (k, m) of an LED of light-emitting devices 11 (see, e.g., FIG. 5A) shows that the LED is the k-th one in the row direction and m-th one in the column direction.

There exist m anode sections AL1 to ALm in column direction Y. Anode wirings 9 are connected to anode driver IC 4. There exist k cathode sections CL1 to CLk in row direction X. Cathode wirings 10 are connected to cathode driver IC 51 or 52. When two cathode driver ICs are used, cathode channels Cch in odd-numbered rows are connected to cathode driver IC 51, and cathode channels Cch in even-numbered rows are connected to cathode driver IC 52.

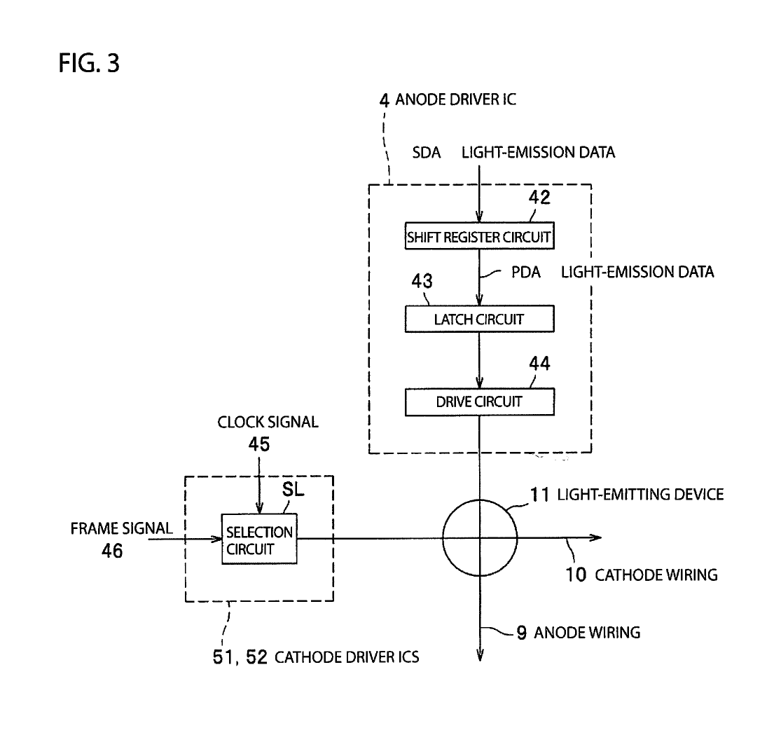

FIG. 3 is a schematic configuration diagram showing a configuration of anode driver IC 4 and cathode driver ICs 51, 52 in FIG. 2.

Anode driver IC 4 has a function of applying a current to one of columns of light-emitting devices 11 connected to anode wirings 9 of light-emitting device array chip 3 in accordance with display data (for example, unillustrated light-emission data DA indicating whether or not corresponding light-emitting device 11 is to emit light) outputted from an unillustrated controller. Anode driver IC 4 includes: shift register circuit 42 configured to receive serial light-emission data SDA, for example, outputted from the unillustrated controller and to output parallel light-emission data PDA; and latch circuit 43 connected to shift register circuit 42 on the output side of shift register circuit 42. Latch circuit 43 latches parallel light-emission data PDA outputted from shift register circuit 42 and is connected to drive circuit 44 on its output side. Drive circuit 44 amplifies output from latch circuit 43 and is connected to anode wirings 9 on its output side.

Each of cathode driver ICs 51, 52 has a function of scanning one of the rows of light-emitting devices 11 connected to cathode wirings 10 of light-emitting device array chip 3. This scanning is based on clock signal 45 and frame signal 46 outputted from the unillustrated controller, and is formed by selection circuit SL and the like having a selector function.

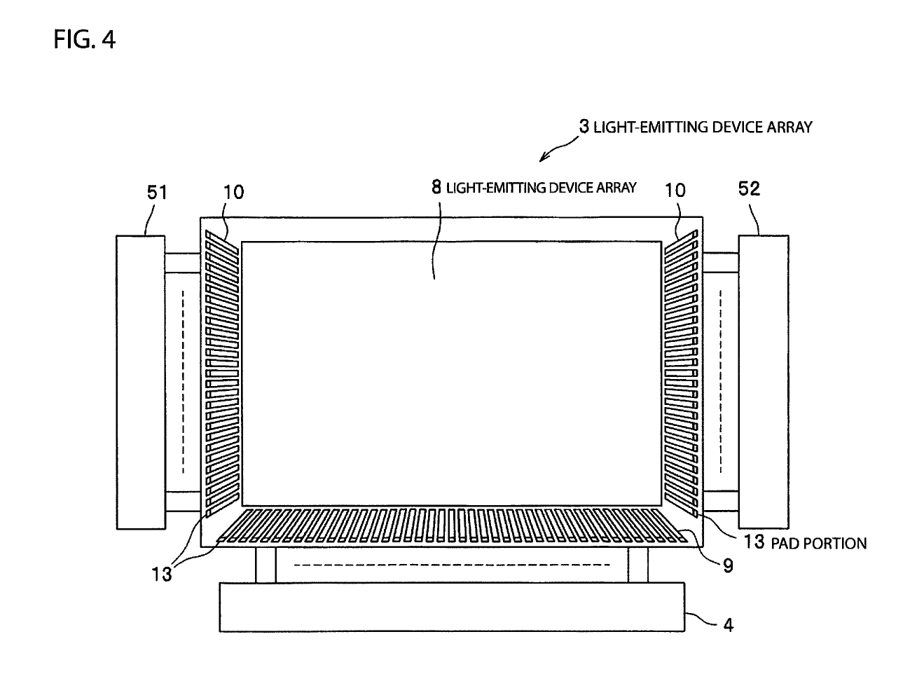

FIG. 4 is an outline planar diagram of the light-emitting device array chip 3 in FIG. 1. Light-emitting device array chip 3 includes substrate 12 (see FIG. 5B) and light-emitting device array 8 formed on substrate 12.

Anode wirings 9 and cathode wirings 10 extend to reach an outer peripheral portion of substrate 12 and are connected to pad portions 13 which are wire bonding pads or the like. Anode wirings 9 are electrically connected to anode driver IC 4 through pad portions 13, and cathode wirings 10 are also electrically connected to cathode driver ICs 51, 52 through pad portions 13.

If a pitch of light-emitting devices 11 differs, on the light-emitting device array chip 3, from a pitch of pads to be formed on the driver IC side, pad portions 13 are formed on light-emitting device array chip 3 at a pitch appropriate for the driver IC side, and wiring for the connection is performed in an inclined manner as shown in FIG. 4. This enables a regular pad pitch. If the pitch of light-emitting devices 11 is the same as the pitch of the pads on the driver IC side, the wiring for the connection does not have to be performed in the inclined manner.

FIG. 5A is a plan diagram of pixels in a 4×4 matrix showing a part of light-emitting device array 8 in FIG. 4.

In FIG. 5A, (4 pieces of) anode wirings 9 arranged in column direction (the vertical direction) Y and (4 pieces of) cathode wirings 10 arranged in row direction (the horizontal direction) X orthogonal to anode wirings 9 are electrically insulated from each other by an unillustrated interlayer insulating film. As a material of anode wirings 9 and cathode wirings 10, an Au-based metal wiring material such as Au, Ti/Pt/Au, Ti/Au, AuGeNi/Au or AuGe/Ni/Au, or an Al-based metal wiring material such as Al, Ni/Al, Ni/AlNi, Ni/AlSiCu or Ti/Al, for example, may be used. Note that the wiring material is used which has such a thickness that causes a higher thermal conduction than heat dissipation to the interlayer insulating film and thin-film semiconductor layer 17, the higher thermal conduction being attributable to a metal.

In addition, (4×4=16) light-emitting devices 11 connected to crossing points are arranged in a two-dimensional matrix. In FIG. 5A, a unit pixel of the matrix is denoted by A1 in a broken line surrounding one of light-emitting devices 11. Microlenses 14 are respectively formed in light-emitting devices 11 arranged in the matrix. Microlenses 14 are respectively arranged in unit pixels A1, and the pitch of microlenses 14 is the same as that of light-emitting devices 11. The center of each microlens 14 is located in the center (a center portion) of corresponding light-emitting device 11. Microlens 14 is designed so that light emitted from light-emitting device 11 can efficiently converge. Here, a planar shape of each microlens 14 shown in FIG. 5A is preferably a circle separated from adjacent ones, but may be a square with its corners rounded.

FIG. 5B is a cross-sectional diagram of unit pixel Al shown in the broken line in FIG. 5A in the row direction (a cross section taken along line X-11 in the horizontal direction). FIG. 5C is a cross-sectional diagram of unit pixel A1 in the column direction (a cross section taken along line Y-11 in the vertical direction).

In FIG. 5B, insulating film layer 15 is formed on a surface of substrate 12. For example, a semiconductor substrate made of Si, GaAs, GaP, InP, GaN, ZnO or the like, a ceramic substrate made of AlN, Al₂O₃ or the like, a glass epoxy substrate, a metal substrate made of Cu, Al or the like, or a plastic substrate may be used as substrate 12. As for insulating film layer 15, an inorganic insulating film made of silicon oxide, silicon nitride or the like, or an organic insulating film made of polyimide or the like, may be used. Note that when an insulating substrate is used as the substrate, insulating film layer 15 is not required.

Cathode wirings 10 are formed on insulating film layer 15, and smoothing layer 16 is formed on cathode wirings 10. Smoothing layer 16 is formed by an organic insulating film, such as an application-type resist, and provides smoothness for bonding to thin-film semiconductor layer 17 to be described later.

Thin-film semiconductor layer 17 is bonded to a surface of smoothing layer 16. Thin-film semiconductor layer 17 includes P-type semiconductor layer 19, light-emitting-layer-including semiconductor layer 18, and N-type semiconductor layer 20 in this order from a front surface of thin-film semiconductor layer 17. N-type semiconductor layer 20, which is the lowest layer, is bonded to smoothing layer 16. Light-emitting-layer-including semiconductor layer 18 is a layer including a multi quantum well (MQW) active layer and the like. P-type semiconductor layer 19 is bonded to each anode wiring 9. P-type semiconductor layer 19, light-emitting-layer-including semiconductor layer 18, and a part of N-type semiconductor layer 20 are formed to have a mesa structure by etching.

P-type semiconductor layer 19 includes, on a front surface thereof, light-emitting region 24 and connection region 21 connected to one of anode wirings 9. Light emitted from light-emitting-layer-including semiconductor layer 18 is emitted through light-emitting region 24. The front surface of P-type semiconductor layer 19 is in ohmic contact with anode wiring 9 through connection region 21. A part of anode wiring 9 serves as connection region 21.

Anode wiring 9 is electrically isolated from an adjacent one of anode wirings 9 by isolation regions 22, 23. Each anode wiring 9 extends beyond outer ends of corresponding columns of microlenses 14 and is widely formed in a portion excluding isolation regions 22, 23 and light-emitting region 24.

Interlayer insulating film 25 is formed between anode wiring 9 and N-type semiconductor layer 20 and around thin-film semiconductor layer 17. Interlayer insulating film 25 may be formed by an inorganic insulating film made of silicon oxide, silicon nitride or the like, or an organic insulating film made of polyimide or the like.

Each microlens 14 is formed on anode wiring 9 and the front surface of P-type semiconductor layer 19 which is the uppermost surface of light-emitting region 24. Microlenses 14 on adjacent light-emitting devices 11 are formed to be spaced away from one another. Each microlens 14 is shaped into a column having a hemispheric top. An organic resin such as an epoxy or acrylic resin may be used as microlens 14. Note that microlens 14 may be shaped into, for example, a square pole having a squire cross section, instead of the column.

Microlens 14 is designed to have a focal point in a range extending in an up-down direction from the uppermost surface of light-emitting region 24. Accordingly, the width of connection region 21 of anode wiring 9 in contact with the front surface of P-type semiconductor layer 19 is preferably set in such a manner that the width of light-emitting region 24 accounts for 60% or less of the width of unit pixel A1.

Also in FIG. 5C, insulating film layer 15 is formed on substrate 12 as in FIG. 5B. Although cathode wirings 10 are formed on insulating film layer 15, adjacent cathode wirings 10 are electrically isolated by isolation regions 27, 28.

Smoothing layer 16 is formed on cathode wirings 10 as in FIG. 5B, but is partially removed to expose cathode wirings 10 in predetermined regions 30.

Thin-film semiconductor layer 17 is bonded to a front surface of smoothing layer 16. Thin-film semiconductor layer includes P-type semiconductor layer 19, light-emitting-layer-including semiconductor layer 18, and N-type semiconductor layer 20 in this order from the front surface of thin-film semiconductor layer 17. N-type semiconductor layer 20, which is the lowest layer, is bonded to smoothing layer 16. Light-emitting-layer-including semiconductor layer 18 is the layer including the MQW active layer and the like. P-type semiconductor layer 19 is bonded to each anode wiring 9. P-type semiconductor layer 19, light-emitting-layer-including semiconductor layer 18, and a part of N-type semiconductor layer 20 are formed to have a mesa structure by etching.

N-type semiconductor layer 20 is in ohmic contact with corresponding cathode wiring 10 in connection portion 29 through N-contact metals 26. Interlayer insulating film 31 is formed on a back surface of N-contact metals 26 to prevent N-contact metals 26 from being broken. An inorganic insulating film made of silicon oxide, silicon nitride or the like, or an organic insulating film made of polyimide or the like may be used as interlayer insulating film 31. Note that if there is no risk of broken N-contact metals 26, interlayer insulating film 31 does not have to be formed.

The front surface of P-type semiconductor layer 19 is in ohmic contact with anode wiring 9 through connection region 21.

Interlayer insulating film 25 is formed between anode wiring 9 and N-type semiconductor layer 20 and around thin-film semiconductor layer 17. An inorganic insulating film made of silicon oxide, silicon nitride or the like, or an organic insulating film made of polyimide or the like may be used as interlayer insulating film 25.

Each microlens 14 is formed on front surfaces of corresponding anode wiring 9 and P-type semiconductor layer 19.

Next, by appropriately referring to the drawings, descriptions are provided for the steps of forming light-emitting device array 8 and microlens 14. These steps are: (1) a releasing step, (2) a bonding step, (3) a step of forming light-emitting device 11, (4) a passivation step, (5) a step of forming microlens 14, and (6) a thinning-out step.

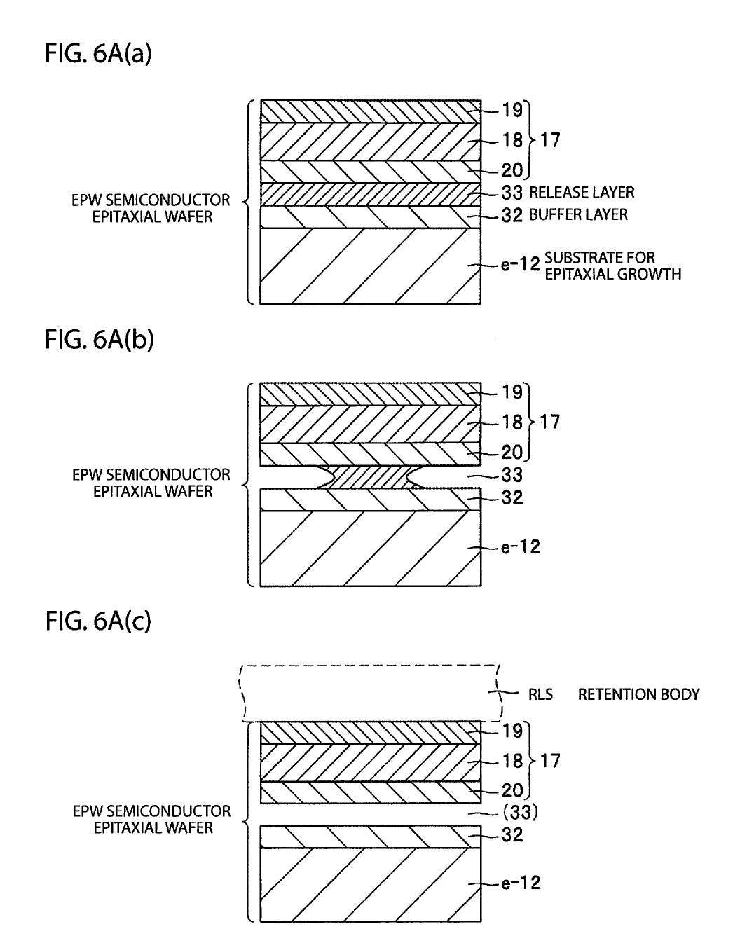

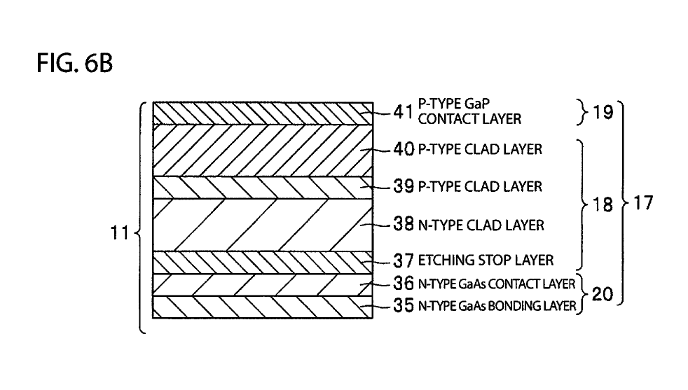

FIGS. 6A(a) to 6A(c) are schematic diagrams illustrating the releasing step. FIG. 6A(a) is a cross-sectional diagram showing a schematic structure example of semiconductor epitaxial wafer EPW observed in forming light-emitting device 11 in FIG. 5A using thin-film semiconductor layer 17. FIG. 6A(b) is a cross-sectional diagram illustrating a schematic structure example of semiconductor epitaxial wafer EPW observed halfway in an etching step in which thin-film semiconductor layer 17, forming light-emitting device 11 shown in FIG. 6A(a), is released from substrate for epitaxial growth e-12. FIG. 6A(c) is a cross-sectional diagram illustrating a schematic structure example of semiconductor epitaxial wafer EPW observed after the etching step in FIG. 6A(b) is completed.

In FIGS. 6A(a) to 6A(c), buffer layer 32, release layer 33, and thin-film semiconductor layer 17 forming light-emitting device 11 are laminated in this order on substrate for epitaxial growth e-12 provided for growing an epitaxial semiconductor layer. Release layer 33 is a so-called sacrificial layer provided to release thin-film semiconductor layer 17 from substrate for epitaxial growth e-12. Thin-film semiconductor layer 17 has a laminated structure including N-type semiconductor layer 20 in contact with release layer 33, light-emitting-layer-including semiconductor layer 18, and uppermost P-type semiconductor layer 19 which are described with reference to FIGS. 5B and 5C.

In other words, light-emitting device 11 in FIGS. 5A to 5C is formed by thin-film semiconductor layer 17 having only the epitaxial semiconductor layers (epitaxial films) and excluding substrate for epitaxial growth e-12.

(1) Releasing Step

Release layer 33 in FIG. 6A(a) is a layer etched by an etching solution or the like at a higher etching speed than the speed of etching thin-film semiconductor layer 17 and substrate for epitaxial growth e-12. N-type semiconductor layer 20, light-emitting-layer-including semiconductor layer 18, and uppermost P-type semiconductor layer 19 in thin-film semiconductor layer 17 are semiconductor layers not etched in the etching step for releasing release layer 33.

Accordingly, in a method of manufacturing thin-film semiconductor layer 17, release layer 33 of semiconductor epitaxial wafer EPW in FIG. 6A(a), for example, is selectively etched by using the etching solution or the like by utilizing the etching speed difference, as shown FIG. 6A(b). Then, as shown in FIG. 6A(c), thin-film semiconductor layer 17 above release layer 33 is released from substrate for epitaxial growth e-12.

(2) Bonding Step

Thin-film semiconductor layer 17 thus released is bonded to substrate 12, different from substrate for epitaxial growth e-12, by utilizing intermolecular force, substrate 12 being described with reference to FIGS. 5B and 5C. In the bonding step, a bonded surface of thin-film semiconductor layer 17 is appropriately subjected to activation processing. Then, thin-film semiconductor layer 17 is brought into close contact with substrate 12 at a predetermined position, and a pressure is applied thereto. After the bonding step, a heating processing may be performed as necessary to enhance the bonding power. In addition, smoothing layer 16 in FIGS. 5B and 5C for smoothing the front surface of thin-film semiconductor layer 17 may be provided in advance in a region of substrate 12 in which thin-film semiconductor layer 17 is to be bonded thereto. Alternatively, thin-film semiconductor layer 17 may be bonded to substrate 12 with an adhesive layer made of an adhesive material placed therebetween.

Here, to release thin-film semiconductor layer 17 from substrate for epitaxial growth e-12 and bond thin-film semiconductor layer 17 to substrate 12, a transfer substrate or retention body RLS shown as a broken line in FIG. 6A(c) may be used to retain thin-film semiconductor layer 17. In this case, an upper surface of thin-film semiconductor layer 17 may be bonded to substrate 12, the upper surface facing upward when thin-film semiconductor layer 17 is placed on the transfer substrate or retention body RLS. In the latter case using the transfer substrate or retention body RLS, the transfer substrate or retention body RLS is removed after the bonding.

(3) Step of Forming Light-Emitting Device 11

After thin-film semiconductor layer 17 is bonded to substrate 12, the step of forming light-emitting device 11 is performed. Selective etching is performed to have a mesa structure by utilizing the effects of dry etching using a reactive gas or by wet etching using an etching solution, so that light-emitting device 11 is formed in a precursor state in which thin-film semiconductor layer 17 is to be electrically isolated for each unit pixel.

Subsequently, as shown in FIG. 5C, light-emitting device 11 is formed by appropriately forming: N-contact metals 26 for ohmic contact between N-type semiconductor layer 20 and cathode wiring 10; metals for the ohmic contact with P-type semiconductor layer 19 and for forming anode wiring 9; interlayer insulating film 25 for preventing short-circuits of cathode wiring 10 and anode wiring 9; and the like.

(4) Passivation Step

Thereafter, for protecting light-emitting device 11, an unillustrated passivation film is formed on anode wiring 9 and the uppermost surface of P-type semiconductor layer 19. A material such as a nitride film having high transmittance for emission wavelength light from light-emitting device 11 is selected and used as the passivation film.

(5) Forming Microlens 14 (see FIGS. 5A to 5C)

Microlens 14 is formed on anode wiring 9 and the uppermost surface of P-type semiconductor layer 19 of each light-emitting device 11. Microlens 14 may be formed, for example, by using a mold or a heat reflow effect after patterning in a photo lithography process. A material of microlens 14 is removed from a non-spontaneous light-emitting region (such as pad portions 13 in FIG. 4) in the photo lithography process.

### Concrete Structure of LED

FIG. 6B is a cross-sectional diagram for explaining an example of a concrete structure of light-emitting device 11 in FIG. 6A. From light-emitting device 11 shown in FIG. 6B, light having wavelengths of yellowish green to red, for example, is emitted.

A structure of thin-film semiconductor layer 17 of light-emitting device 11 in FIGS. 5A to 5C is concretely described with reference to FIG. 6B.

N-type semiconductor layer 20 located lowermost in thin-film semiconductor layer 17 includes N-type GaAs bonding layer 35 and N-type GaAs contact layer 36. Light-emitting-layer-including semiconductor layer 18 above N-type semiconductor layer 20 includes: Al_{y}In_{1-y}P etching stop layer 37; N-type Al_{y}In_{1-y}P clad layer 38; non-doped MQW active layer 39 including many laminated pairs of a Ga_{y}In_{1-y}P well layer as an active layer and an (AlₓGa₁₋ₓ)_{y}In_{1-y}P barrier layer; and P-type Al_{y}In_{1-y}P clad layer 40. Uppermost P-type semiconductor layer 19 is formed by P-type GaP contact layer 41. Accordingly, in light-emitting device 11, P-type semiconductor layer 19 to be connected to anode wiring 9 is P-type GaP contact layer 41. Note that chemical symbols of mixed crystals (such as Al_{y}In_{1-y}P) are not described in FIG. 6B.

When the layers located on the upper side (on the front surface side) of thin-film semiconductor layer 17 are removed by etching or the like in the step of forming light-emitting device 11, N-type GaAs contact layer 36 is exposed to form an N contact on a surface thereof. When the layers located on the upper side of thin-film semiconductor layer 17 are removed by etching or the like in the step of forming light-emitting device 11, Al_{y}In_{1-y}P etching stop layer 37 stops the etching or reduces the etching speed. In addition, MQW active layer 39 forms a light-emitting layer, being sandwiched between N-type Al_{y}In_{1-y}P clad layer 38 and P-type Al_{y}In_{1-y}P clad layer 40.

Here, values of x and y used to represent an Al composition ratio, an In composition ratio, and a Ga composition ratio which are ratios for mixed crystals in the semiconductor layers are preferably 0.5 for grating constant consistency, and are in a range between 0.48 and 0.52 in the case of an effective composition ratio. As for an emission wavelength of light emitted from MQW active layer 39, a desirable emission wavelength in a range between 580 nm and 660 nm (yellowish green to red) can be obtained by setting the values of x and y in the aforementioned range in an epitaxial crystal growth process. Although the multiple quantum well (MOW) structure is used in this embodiment, a single quantum well (SQW) structure may be used.

Meanwhile, a conventional light-emitting device array requires removal of a lens material on the bonding pads on the light-emitting device array because an on-chip microlens array is to be formed on the light-emitting device array. As a method of manufacturing the on-chip microlens array on the light-emitting device array, for example, a method is known with which the top of glass is formed into a bowl shape (a lens shape inverted in the up-down direction) by dry etching or the like, and an application-type lens material is patterned by photo lithography and then is bonded to the light-emitting device array as the on-chip microlens array.

### Operations and Effects

Next, operations and effects of image display module 1 in this embodiment and head up display apparatus 100 including image display module 1 are described by appropriately referring to the drawings.

In image display module 1 in FIG. 1, the dot matrix formed by light-emitting devices 11 is driven by cathode driver ICs 51, 52 in such a passive manner that cathode channels Cch in FIG. 2 are scanned upward from the bottom. In other words, a certain one of light-emitting devices 11 which emits light at certain time is located only on one of cathode wirings 10 in corresponding cathode channel Cch.

For this reason, a current introduced from one of anode channels Ach in FIG. 3 into anode driver IC 4 flows to one of light-emitting devices 11 through corresponding anode wiring 9. Then, the current is drawn into one of cathode driver ICs 51 and 52 through a certain one of cathode wirings 10 and corresponding cathode channel Cch in the one of cathode driver ICs 51 and 52.

Further, a description is provided for a detailed operation of image display module 1. With reference to FIG. 3, when information to be displayed is inputted to the unillustrated controller, the controller outputs serial light-emission data SDA to anode driver IC 4 in accordance with the information to be displayed.

Then, serial light-emission data SDA is sequentially stored in shift register 42 in anode driver IC 4 for each light-emitting device 11 in the first row in light-emitting device array 8. Serial light-emission data SDA stored in shift register 42 is converted into parallel light-emission data PDA by shift register 42 and then is stored in latch circuit 43. Drive circuit 44 is driven in accordance with a signal outputted from latch circuit 43. A constant current flows from drive circuit 44 to an anode terminal of each light-emitting device 11 through corresponding anode wiring 9.

When clock signal 45 and frame signal 46 are outputted from the unillustrated controller to one of cathode driver ICs 51, 52, selection circuit SL in the one of cathode driver ICs 51, 52 selects one of cathode wirings 10 in the first row in light-emitting device array 8. Accordingly, drive circuit 44 causes a drive current to flow from anode wirings 9 in the first row in light-emitting device array 8 to each light-emitting device 11 in the first row to operate depending on serial light-emission data SDA to emit light.

Such a light emitting operation is repeated as many times as the number of cathode wirings 10 (that is, the number of rows in light-emitting device array 8), so that light for an image to be displayed on one screen including the information to be displayed is emitted.

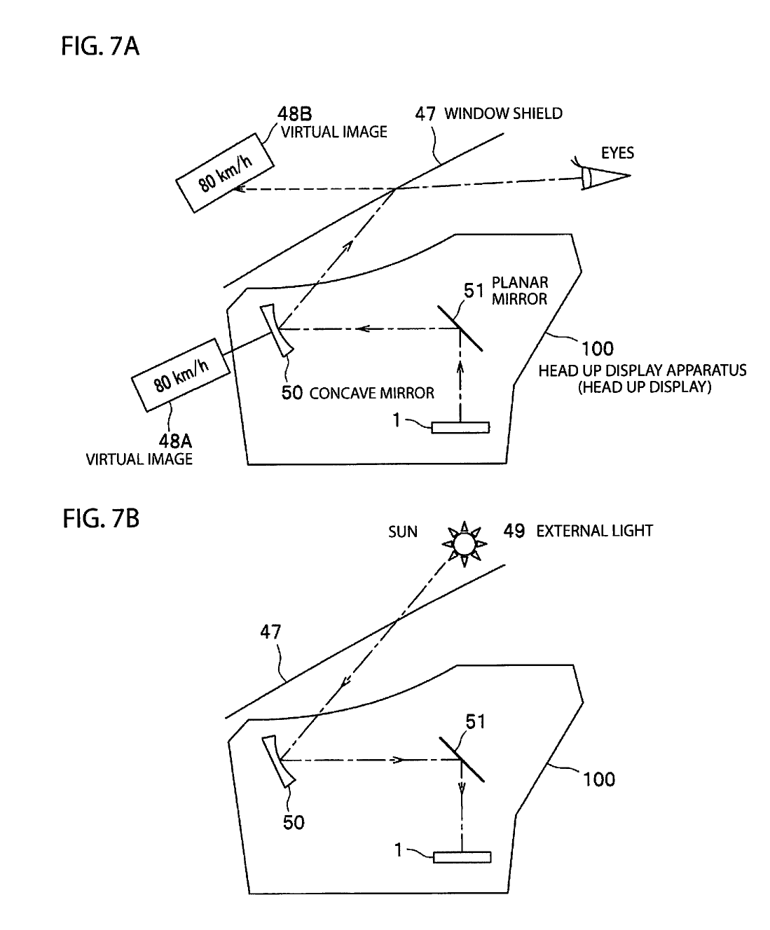

Light emitted from any light-emitting device 11 converges through corresponding microlens 14 in FIGS. 5A, 5B, and 5C, goes out of image display module 1, and reflects on planar mirror 51 and then concave mirror 50 in head up display apparatus 100 as shown in FIG. 7A, so that virtual image 48A is formed. The driver of a vehicle sees, as virtual image 48B, virtual image 48A showing “80 km/h” ahead of window shield 47, for example, through a semitransparent mirror formed on window shield 47 ahead of the driver and outside of head up display apparatus 100.

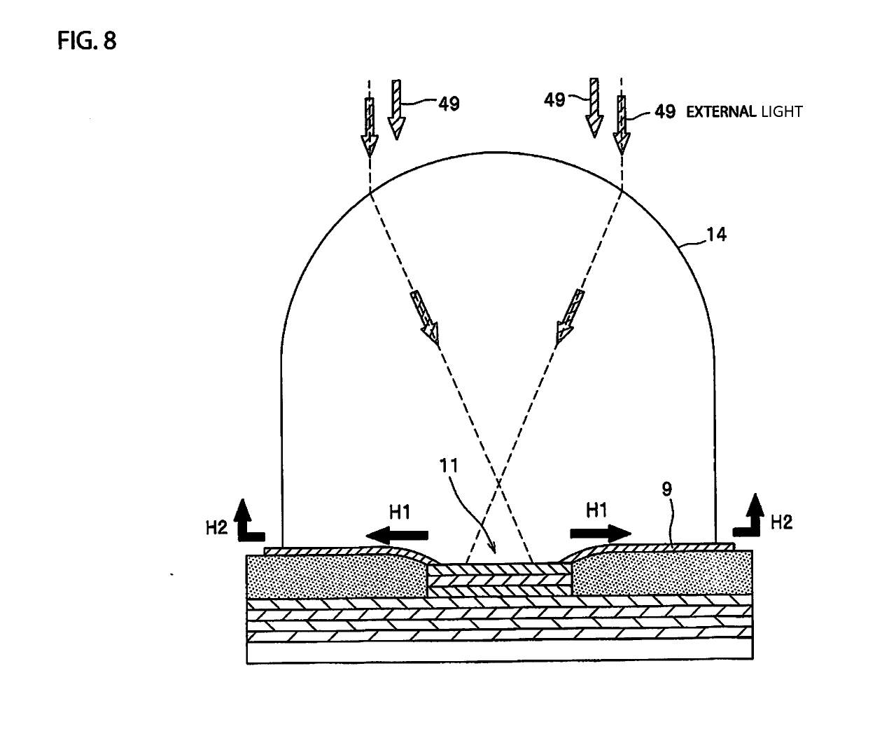

In contrast, when entering head up display apparatus 100 as shown in FIG. 7B, external light 49 such as sun light is guided by concave mirror 50 and planar mirror 51 to reach light-emitting device array 8 in image display module 1. Then, as shown in FIG. 8, external light 49 shown by hatched arrows is concentrated on each light-emitting device 11 by a corresponding microlens 14 on light-emitting device array 8, and generates heat locally.

The heat locally generated due to light concentration at light-emitting device 11 is conducted in directions shown by thick arrows H1 as shown in FIG. 8, and is diffused in entire light-emitting device 11 along anode wiring 9, which is provided in close contact with light-emitting device 11 and is made of a metal with a higher heat conductivity than those of light-emitting device 11 and interlayer insulating film 25. The diffused heat is conducted in directions shown by thick arrows H2 to the air from a part of anode wiring 9 outside microlens 14 spaced away from each other. This can prevent device performance deterioration of light-emitting device array 8 due to heat from light-emitting device 11.

As described above, according to this embodiment, when entering head up display apparatus 100, external light 49 such as sun light is concentrated at each light-emitting device 11 through a corresponding microlens 14 on light-emitting device array 8 included in image display module 1. The heat thus generated locally can be diffused and conducted to the outside of a light-emitting device 11 region through anode wiring 9 formed in close contact with light-emitting device 11. This can prevent device performance deterioration due to heat from light-emitting device 11.

The description has been provided in this embodiment for microlenses 14 each shaped into a column and spaced away from each other. However, even microlenses 14 each shaped into a square pole can exert the same effect of the function of microlenses 14, as long as the top of each microlens 14 has a spherical lens shape.

Microlenses 14 may have thin bottoms connected to each other. In this case, what is required is to set a thickness of the bottoms in consideration of heat conductivity of connection portions for connecting microlenses 14, that is, a thickness in a range in which the effect of heat conduction shown in thick arrows H2 described with reference to FIG. 8 is equivalent to the heat conduction of the air.

### Second Embodiment

### Configuration

In the First Embodiment described above, anode wirings 9 are formed in contact with light-emitting devices 11 to enhance heat diffusion. External light 49 such as sun light enters head up display apparatus 100, is guided by concave mirror 50 and planar mirror 51 to reach light-emitting device array 8, and is concentrated by each microlens 14 on light-emitting device array 8 to reach a corresponding light-emitting device 11. Heat locally generated in light-emitting device 11 is diffused in the entire light-emitting device 11 to thereby prevent device performance deterioration of light-emitting device 11.

However, when concentrated external light 49 is reflected on anode wirings 9 and is absorbed, for example, by microlenses 14 or the like, the temperature environment around light-emitting devices 11 might be changed to cause device deterioration.

Hence, in this embodiment, black resist 52 is further applied to upper layers of anode wirings 9 formed in contact with light-emitting devices 11 in the light-emitting device array 8 in the configuration of the First Embodiment. Note that parts in the same structure as in the First Embodiment are denoted by the same reference symbols, and a description thereof is omitted.

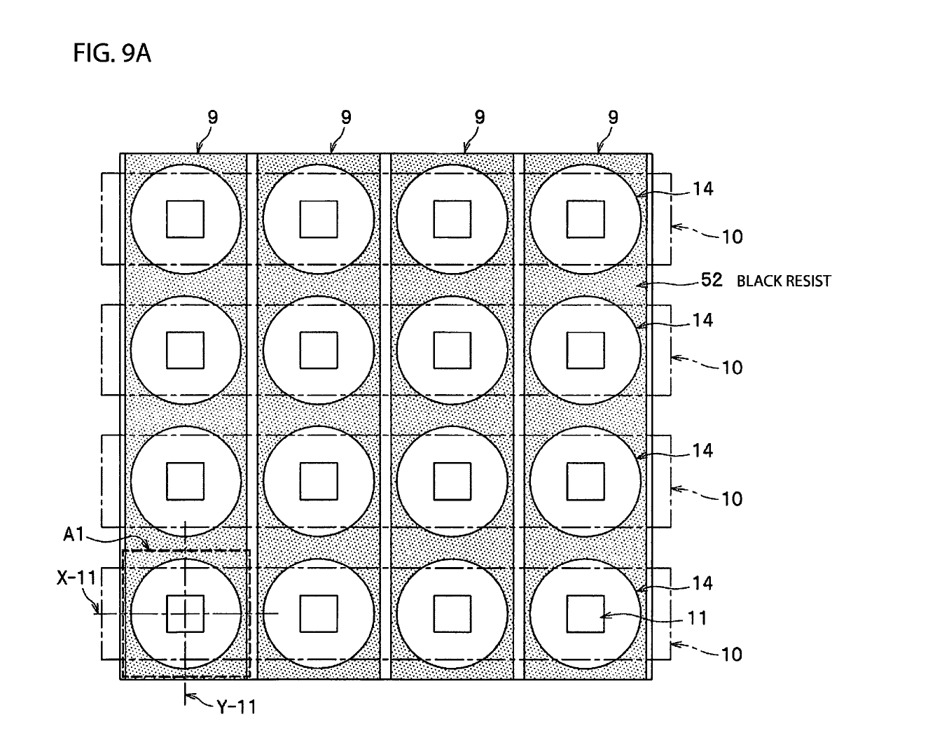

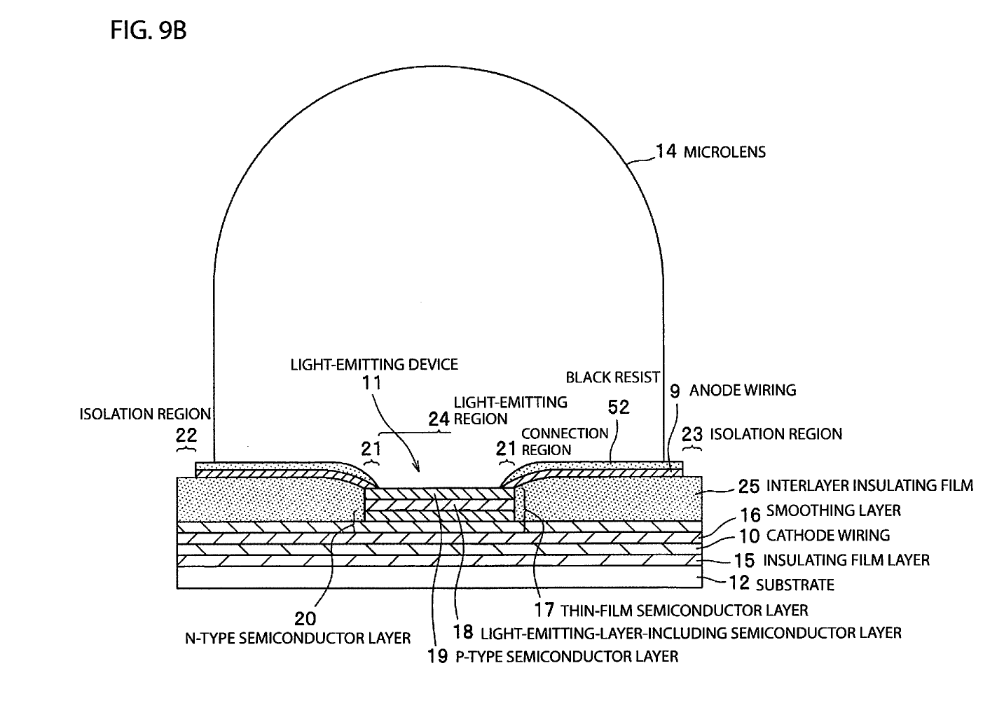

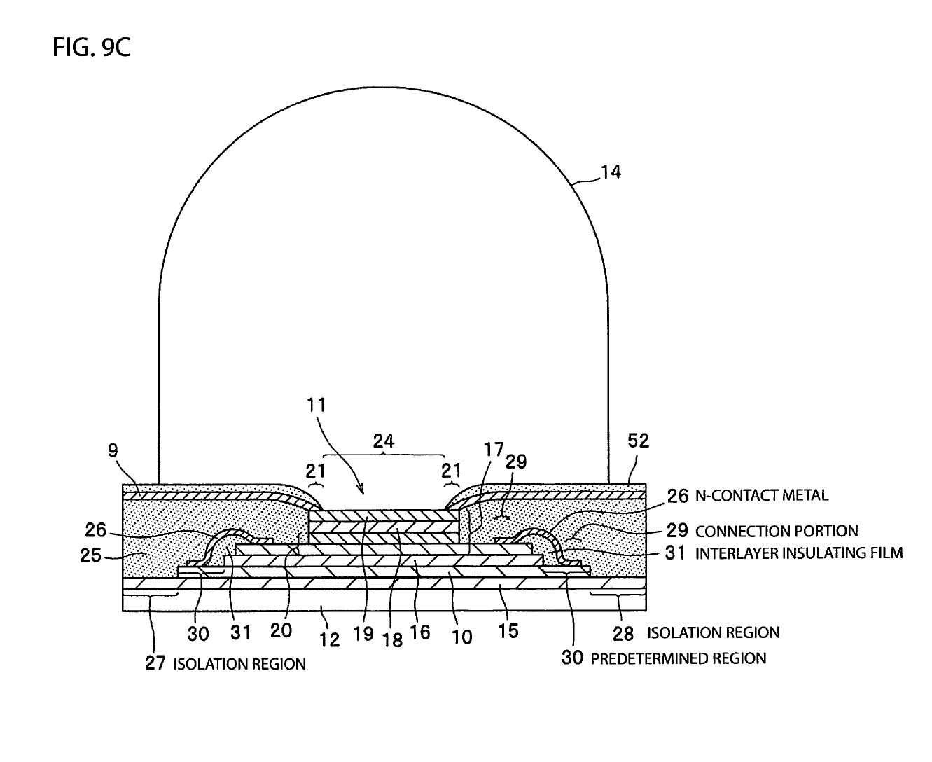

With reference to FIGS. 9A to 9C, a description is provided for light-emitting devices 11 and a 4×4 matrix of light-emitting device array 8 which have black resist 52 applied thereto in the Second Embodiment.

Black resist 52 is applied by a spin coat method, for example. Black resist 52 can be patterned in the photolithography process. Examples of a composition of black resist 52 include a binder resin made of a polyimide resin and a titan black component as a black color agent. Black resist 52 is a material having not only a light absorption optical characteristic but also an insulating electrical characteristic. A passivation film for surface protection is formed on black resist 52 as in the First Embodiment.

### Operations and Effects

External light 49 such as sun light is concentrated as in the First Embodiment, and black resist 52 formed on anode wirings 9 prevents its reflection and absorbs heat. Thereby, the surrounding temperature environment can be kept constant. The heat absorbed by black resist 52 is diffused to the outside by anode wirings 9.

As described above, according to the Second Embodiment, external light 49 such as sun light enters head up display apparatus 100, is guided by concave mirror 50 and planar mirror to reach anode wirings 9 formed in contact with light-emitting devices 11, is absorbed by black resist 52 patterned on anode wirings 9, and is diffused to the outside through anode wirings 9. This can keep the surrounding temperature environment constant and thereby prevent deterioration of light-emitting devices 11.

In addition, black resist 52 absorbs light from regions other than light-emitting region 24, and thus provides an effect such that the contrast of light emitted from light-emitting region 24 can be made clear.

Moreover, black resist 52 has insulating properties, and thus may be formed on an entire surface of the regions except light-emitting region 24 by releasing the restriction of the patterning in anode wirings 9.

As described above, the light-emitting panel and the head up display including the light-emitting panel according to the invention makes it possible to effectively release heat that external light such as sun light generates locally in light-emitting devices and thus to prevent characteristic deterioration due to temperature rise in the light-emitting devices.

The invention includes other embodiments in addition to the above-described embodiments without departing from the spirit of the invention. The embodiments are to be considered in all respects as illustrative, and not restrictive. The scope of the invention is indicated by the appended claims rather than by the foregoing description. Hence, all configurations including the meaning and range within equivalent arrangements of the claims are intended to be embraced in the invention.

What is claimed is:

1. A light-emitting panel comprising:
a substrate;
semiconductor light-emitting devices each having a first surface and a second surface, the first surface being placed on a surface of the substrate;
lenses each provided in close contact with at least a center portion of the second surface of a corresponding semiconductor light-emitting device; and
a connection wiring being in contact with a region around the center portions while having openings corresponding to the respective center portions.

2. The light-emitting panel according to claim 1, wherein
adjacent lenses are spaced away from each other, and
the connection wiring extends to a region between the adjacent lenses.

3. The light-emitting panel according to claim 1, wherein each of the lenses is a columnar body having one end portion and the other end portion opposite from one end portion, such that the one end portion being in contact with the center portion and the other end portion has a convex shape.

4. The light-emitting panel according to claim 1, wherein the connection wiring is metal.

5. The light-emitting panel according to claim 1, further comprising a black insulating layer on an opposite side of the connection wiring from the side in contact with the region around the center portions of the semiconductor light-emitting devices.

6. The light-emitting panel according to claim 1, wherein a bottom area of each lens is larger than an area of a light-emitting layer of each of the semiconductor light-emitting devices.

7. A head up display comprising:
the light-emitting panel according to claim 1; and
an optical system configured to visualize, as a virtual image, an image formed by the light-emitting panel.

8. The light-emitting panel according to claim 1, wherein the semiconductor light-emitting devices are thin-film semiconductor light-emitting devices.

9. The light-emitting panel according to claim 1, wherein the semiconductor light-emitting devices are arranged in two dimensions.

10. The light-emitting panel according to claim 1, wherein the semiconductor light-emitting devices are arranged in a matrix with rows and columns, such that each of the rows extends in a first direction and each of the columns extends in a second direction being not parallel to the first direction.

11. The light-emitting panel according to claim 10, wherein
a connection wiring comprises a plural connection wirings, and
each of the connection wirings extends in the first direction and connects to all of the semiconductor light-emitting devices in each row, as a common wiring for each row.

12. The light-emitting panel according to claim 10, wherein
a connection wiring comprises a plural connection wirings, and
each of the connection wirings extends in the second direction and connects to all of the semiconductor light-emitting devices in each column, as a common wiring for each column.

13. The light-emitting panel according to claim 10, wherein
a connection wiring comprises a plural first connection wirings and a plural second connection wirings,
each of the first connection wirings extend in the first direction and connects to all of the semiconductor light-emitting devices in each row, as a common wiring for each row, and
each of the second connection wirings extend in the second direction and connects to all of the semiconductor light-emitting devices in each column, as a common wiring for each column.

14. The light-emitting panel according to claim 13, wherein
each of the first connection wirings is one of a cathode wiring or an anode wiring, whereas each of the second connection wirings is the other of the cathode wiring or the anode wiring.
